(19) United States
(12) Patent Application Publication
(10) Pub. No.: US 2019/0333011 A1
(43) Pub. Date: Oct. 31, 2019

(54) ORDER PROCESSING SYSTEM, METHOD, AND DEVICE

(71) Applicant: ALIBABA GROUP HOLDING LIMITED, George Town (KY)

(72) Inventor: Liangfan WEN, Hangzhou (CN)

(21) Appl. No.: 16/505,634

(22) Filed: Jul. 8, 2019

Related U.S. Application Data
(63) Continuation of application No. PCT/CN2017/118523, filed on Dec. 26, 2017.

(30) Foreign Application Priority Data
Jan. 6, 2017 (CN) 201710010765.7

(51) Int. Cl. G06Q 10/08

(52) U.S. Cl. CPC G06Q 10/087; G06Q 10/08355

(57) ABSTRACT

The present disclosure provides order processing systems, methods, and devices, and order-picking batch generation methods and devices. One exemplary order processing apparatus is configured to: generate a corresponding order according to commodity ordering information input by a user; determine whether a back-of-house stock quantity of a commodity object related to the order satisfies the order quantity; and if the back-of-house stock quantity of the commodity object related to the order satisfies the order quantity, perform back-of-house stock occupation for the commodity object related to the order and label the stock occupation type of the order as a back-of-house type. Order processing solutions provided in the present disclosure can avoid the problem of failed order-picking and delivery due to insufficient stock of online orders, thereby improving order-picking and delivery efficiency.

### CROSS-REFERENCE TO RELATED APPLICATION

This application claims priority to International Application No. PCT/CN2017/118523, filed on Dec. 26, 2017, which claims priority to and the benefits of priority to Chinese Application No. Chinese Patent Application No. 201710010765.7, filed on Jan. 6, 2017, both of which are incorporated herein by reference in their entireties.

### TECHNICAL FIELD

This application generally relates to the field of data processing technologies, and in particular, to order processing systems, methods, apparatuses and electronic devices, and order-picking batch generation methods, apparatuses, and electronic devices.

### BACKGROUND

Operation of a fresh produce store can be similar to that of a supermarket. A fresh produce store offers fresh produce and may support both online and offline purchasing. When a user purchases a commodity through an online application (APP) platform, a payment can be made through a third-party payment account. If the user purchases commodities directly in the store, the payment can be made through a point of service (POS) machine at the store.

Some fresh produce stores provide home delivery services for online orders. To deliver an online-ordered commodity to a customer's home, order-picking is one of the steps in the process. That is, an order-picker picks out the commodity associated with the order. Delivery can then be performed, by which the picked commodity is delivered by a deliverer. Some fresh produce stores offer simultaneous online and offline sales, and the commodities are usually stored in the front-of-house of the store. The following problem may occur: a user successfully orders a commodity online, but an order-picker, during the order-picking process, finds out that the commodity has been purchased offline. In that case, the online order cannot be picked and delivered.

To improve order-picking efficiency and delivery speed, multiple order-picking waves can be formed for online orders based on a certain batching rule. That is, orders of the same order-picking wave are order-picked jointly and delivered jointly. When the orders of an order-picking wave are picked, if one commodity of this wave has insufficient stock due to the aforementioned stock competition issue, the overall delivery speed of the orders in this wave will be affected.

In light of the above, when commodities are sold online and offline simultaneously, there is a problem of failed order-picking and delivery due to insufficient stock of the online-ordered commodities.

### SUMMARY

The present disclosure discloses order processing systems. The present disclosure further provides order processing methods, apparatuses, and electronic devices, and order-picking batch generation methods, apparatuses, and electronic devices. One advantage of the embodiments provided herein is to address the problem of failed order-picking and delivery due to insufficient stock of online-ordered commodities.

According to some embodiments, order processing systems are provided. One exemplary order processing system includes: an order processing apparatus and an order-picking batch generation apparatus. The order processing apparatus can include: an order generation unit, a back-of-house stock determination unit, and a back-of-house order processing unit.

The order generation unit can be configured to generate a corresponding order according to commodity ordering information input by a user. The back-of-house stock determination unit can be configured to: determine whether the back-of-house stock quantity of a commodity object related to the order satisfies the order quantity; and if the back-of-house stock quantity of a commodity object related to the order satisfies the order quantity, start the back-of-house order processing unit. The back-of-house order processing unit can be configured to perform back-of-house stock occupation for the commodity object related to the order and label the stock occupation type of the order as a back-of-house type.

The order-picking batch generation apparatus can include an order acquisition unit and an order batching unit. The order acquisition unit can be configured to acquire at least one outgoing order. The order batching unit can be configured to include the at least one order in an order-picking batch matching an attribute of the order, according to the stock occupation type of the order.

According to some embodiments, the back-of-house stock determination unit can include a back-of-house stock quantity acquisition sub-unit and a back-of-house stock determination sub-unit. The back-of-house stock quantity acquisition sub-unit can be configured to: acquire, according to a preset storage location occupation rule, storage location information of back-of-house stock that can be occupied by the commodity object, and acquire the back-of-house stock quantity of the commodity object according to the stock quantity of each of the storage locations. The back-of-house stock determination sub-unit can be configured to determine whether the back-of-house stock quantity is greater than or equal to the order quantity.

In some embodiments, the preset storage location occupation rule can include at least one of the following rules: a universal storage location occupation rule for the orders, or a specified storage location occupation rule for the commodity object.

In some embodiments, the commodity object related to the order includes a plurality of commodity objects. The back-of-house stock determination unit can be further configured to: determine whether the back-of-house stock quantity of each of the commodity objects satisfies the corresponding order quantity. The determination result of the unit is yes when the back-of-house stock quantities of the various commodity objects all satisfy the corresponding ordering quantities.

In some embodiments, the order processing apparatus can further include a non-back-of-house order processing unit. If the back-of-house stock quantity of the commodity object related to the order does not satisfy the order quantity, the back-of-house stock determination unit can be configured to start the non-back-of-house order processing unit.

The non-back-of-house order processing unit can be configured to perform stock occupation for the commodity object related to the order according to a preset stock occupation mode; label the stock occupation type of the order as a front-of-house type if the order occupies front-of-house stock; and label the stock occupation type of the order as a front-back-of-house hybrid type if the order occupies front-of-house stock and back-of-house stock.

In some embodiments, the preset stock occupation mode can include at least one of: occupying front-of-house stock after the back-of-house stock is fully occupied, or occupying back-of-house stock after the front-of-house stock is fully occupied.

According to some embodiments, the order batching unit can include a back-of-house order batching sub-unit configured to select orders of the back-of-house type from the at least one order, and include, according to a preset order batching rule, each order of the back-of-house type in a back-of-house order-picking batch matching an attribute of the order.

In some embodiments, the order batching unit can include: a front-of-house order batching sub-unit and a front-back-of-house hybrid order batching sub-unit. The front-of-house order batching sub-unit can be configured to: select orders of the front-of-house type from the at least one order, and include, according to the preset order batching rule, each order of the front-of-house type in a front-of-house order-picking batch matching an attribute of the order. The front-back-of-house hybrid order batching sub-unit can be configured to: select orders of the front-back-of-house hybrid type from the at least one order, and include, according to the preset order batching rule, each order of the front-back-of-house hybrid type in a front-back-of-house hybrid order-picking batch matching an attribute of the order.

According to some embodiments, order processing methods are further provided. One exemplary order processing method includes: generating a corresponding order according to commodity ordering information input by a user; determining whether a back-of-house stock quantity of a commodity object related to the order satisfies the order quantity. If the back-of-house stock quantity of the commodity object related to the order satisfies the order quantity, the method can further include: performing back-of-house stock occupation for the commodity object related to the order, and labeling a stock occupation type of the order as a back-of-house type.

In some embodiments, before determining whether the back-of-house stock quantity of a commodity object related to the order satisfies the order quantity, the method can further include: acquiring, according to a preset storage location occupation rule, storage location information of back-of-house stock that can be occupied by the commodity object; and acquiring the back-of-house stock quantity of the commodity object according to the stock quantity of each of the storage locations.

In some embodiments, the preset storage location occupation rule can include at least one of the following rules: a universal storage location occupation rule for the orders, and a specified storage location occupation rule for the commodity object.

In some embodiments, the commodity object related to the order can include a plurality of commodity objects. Determining whether the back-of-house stock quantity of a commodity object related to the order satisfies the order quantity can include: determining whether the back-of-house stock quantity of each of the commodity objects satisfies the corresponding order quantity, wherein the determination result of this step is yes when the back-of-house stock quantities of the various commodity objects all satisfy the corresponding ordering quantities.

In some embodiments, if the back-of-house stock quantity of the commodity object related to the order does not satisfy the order quantity, the order processing method can further include: performing stock occupation for the commodity object related to the order according to a preset stock occupation mode; labeling the stock occupation type of the order as a front-of-house type if the order occupies front-of-house stock; and labeling the stock occupation type of the order as a front-back-of-house hybrid type if the order occupies front-of-house stock and back-of-house stock.

In some embodiments, the preset stock occupation mode include at least one of include: occupying front-of-house stock after the back-of-house stock is fully occupied, or occupying back-of-house stock after the front-of-house stock is fully occupied.

According to some embodiments, order processing apparatuses are further provided. One exemplary order processing apparatus includes: an order generation unit configured to generate a corresponding order according to commodity ordering information input by a user; a determination unit configured to determine whether the back-of-house stock quantity of a commodity object related to the order satisfies the order quantity; and an execution unit configured to, if the back-of-house stock quantity of a commodity object related to the order satisfies the order quantity, perform back-of-house stock occupation for the commodity object related to the order and label a stock occupation type of the order as a back-of-house type.

According to some embodiments, electronic devices are further provided. One exemplary electronic device includes: a processor; and a memory configured to store a program for implementing an order processing method. When the program of the order processing method is executed by the processor, the following procedures are executed: generating a corresponding order according to commodity ordering information input by a user; determining whether the back-of-house stock quantity of a commodity object related to the order satisfies the order quantity; and if the back-of-house stock quantity of the commodity object related to the order satisfies the order quantity, performing back-of-house stock occupation for the commodity object related to the order, and labeling a stock occupation type of the order as a back-of-house type.

According to some embodiments, order-picking batch generation methods are provided. One exemplary order-picking batch generation method includes: acquiring at least one outgoing order; and including the at least one order in an order-picking batch matching an attribute of the order, according to the stock occupation type of the order.

In some embodiments, the stock occupation types can include at least one of: a back-of-house type, a front-of-house type, or a front-back-of-house hybrid type.

In some embodiments, including the at least one order in an order-picking batch matching an attribute of the order according to the stock occupation type of the order can include: selecting orders of the back-of-house type from the at least one order, and including each order of the back-of-house type in a back-of-house order-picking batch matching an attribute of the order, according to a preset order batching rule; selecting orders of the front-of-house type from the at least one order, and including each order of the front-of-house type in a front-of-house order-picking batch matching an attribute of the order, according to the preset order batching rule; and selecting orders of the front-back-of-house hybrid type from the at least one order, and including each order of the front-back-of-house hybrid type in a front-back-of-house hybrid order-picking batch matching an attribute of the order, according to the preset order batching rule.

According to some embodiments, order-picking batch generation apparatuses are further provided. One exemplary order-picking batch generation apparatus includes: an order acquisition unit configured to acquire at least one outgoing order; and a classifying unit configured to include the at least one order in an order-picking batch matching an attribute of the order, according to the stock occupation type of the order.

According to some embodiments, electronic devices are further provided. One exemplary electronic device includes: a processor; and a memory configured to store a program for implementing an order-picking batch generation method. When the program of the order-picking batch generation method is executed by the processor, the following procedures are executed: acquiring at least one outgoing order; and including the at least one order in an order-picking batch matching an attribute of the order, according to the stock occupation type of the order.

Embodiments of the present disclosure provide at least the following advantages. With the order processing systems provided in some embodiments of the present disclosure, stock of a commodity are separately stored in the front-of-house and the back-of-house of a store, and the commodity storage locations can be set as front-of-house types and back-of-house types. When the store receives an online order, back-of-house stock occupation can be performed for the order. If the back-of-house stock occupation is successful, the stock occupation type of the order can be labeled as the back-of-house type. When an order-picking batch is generated, an outgoing order can be included in an order-picking batch matching an attribute of the order, according to the stock occupation type of the order. In view of the above procedures, stock occupied by online orders can be effectively separated from stock of commodities sold offline, so that online stock and offline stock do not affect each other. That way, the problem of failed order-picking and delivery due to insufficient stock of online orders can be prevented and addressed. Therefore, the order-picking and delivery efficiency can be improved.

### BRIEF DESCRIPTION OF THE DRAWINGS

FIG. 1 is a schematic diagram of an exemplary order processing system according to some embodiments of the present disclosure.

FIG. 2 is a flowchart of an exemplary order processing method according to some embodiments of the present disclosure.

FIG. 3 is a schematic diagram of an exemplary order processing apparatus according to some embodiments of the present disclosure.

FIG. 4 is a schematic diagram of an exemplary electronic device according to some embodiments of the present disclosure.

FIG. 5 is a flowchart of an exemplary order-picking batch generation method according to some embodiments of the present disclosure.

FIG. 6 is a schematic diagram of an exemplary order-picking batch generation apparatus according to some embodiments of the present disclosure.

FIG. 7 is a schematic diagram of an exemplary electronic device according to some embodiments of the present disclosure.

### DETAILED DESCRIPTION

Some exemplary embodiments of the present disclosure are described in detail in the following and are illustrated in the drawings. It is appreciated that the following described embodiments and those illustrated in the drawings are exemplary and are only used to explain the embodiments of the present disclosure. They do not constitute any limitations on the scope of the present disclosure.

According to some embodiments of the present disclosure, stock of a commodity are separately stored in the front-of-house and the back-of-house of a store. The commodity storage locations can be set as set as front-of-house types and back-of-house types. When the store receives an online order, back-of-house stock occupation can be performed for the order. If the back-of-house stock occupation is successful, the stock occupation type of the order is labeled as the back-of-house type. When an order-picking batch is generated, according to the stock occupation type of the orders, an outgoing order can be included in an order-picking batch matching an attribute of the order. Stock occupied by online orders can be separated from stock of commodities sold offline, so that online stock and offline stock do not affect each other. That way, the problem of failed order-picking and delivery due to insufficient stock of online orders can be avoided. Therefore, order-picking and delivery efficiency can be effectively improved.

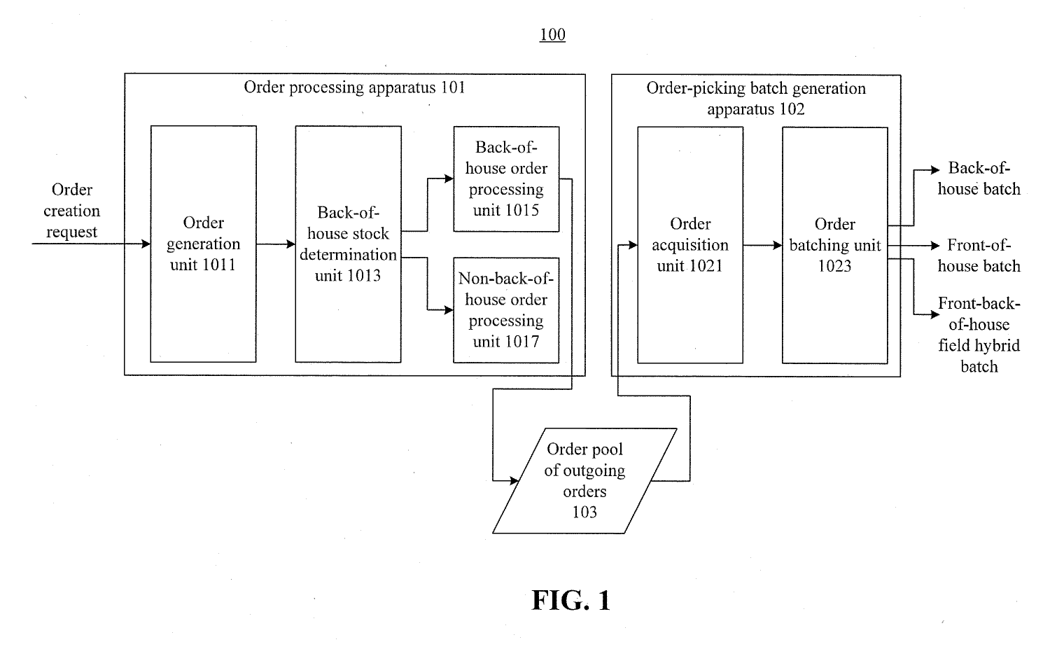

FIG. 1 is a schematic diagram of an exemplary order processing system 100 according to some embodiments. As shown in FIG. 1, system 100 includes an order processing apparatus 101 and an order-picking batch generation apparatus 102.

Order processing apparatus 101 and order-picking batch generation apparatus 102 can be deployed at, but not limited to, a server end. Order processing apparatus 101 can be configured to generate an order and perform stock occupation for a commodity object related to the order. Order-picking batch generation apparatus 102 can be configured to divide outgoing orders into order-picking batches.

Order processing apparatus 101 can include an order generation unit 1011, back-of-house stock determination unit 1013, and a back-of-house order processing unit 1015. Order generation unit 1011 can be configured to generate a corresponding order according to commodity ordering information input by a user. Back-of-house stock determination unit 1013 can be configured to determine whether the back-of-house stock quantity of the commodity object related to the order satisfies the order quantity. If the back-of-house stock quantity of the commodity object related to the order satisfies the order quantity, the process proceeds to back-of-house order processing unit 1015. Back-of-house order processing unit 1015 can be configured to perform back-of-house stock occupation for the commodity object related to the order and label the stock occupation type of the order as a back-of-house type.

In some embodiments, order processing apparatus 101 can further include an order creation request receiving unit configured to receive an order creation request sent by a client terminal. A user of the client terminal may purchase a commodity object through an online platform and trigger an ordering operation. The client terminal can send an order creation request to a server according to the user's ordering operation. The order creation request receiving unit of the server end can then receive the order creation request sent by the client terminal. A corresponding order can be generated by order generation unit 1011 according to the commodity ordering information carried in the order creation request.

When the order is generated, a stock occupation operation needs to be performed for the commodity object related to the order. Stock occupation refers to different procedures than stock deduction. Through the stock occupation operation on the commodity object, an online saleable quantity of the commodity object can be updated. That way, it can be ensured that other users will not use the same stock when placing orders. Stock deduction, on the other hand, refers to an operation of actually updating the stock quantity of a commodity when the commodity leaves the warehouse. That is, stock occupation operation will affect the online saleable quantity of the commodity object, and stock deduction operation will affect the actual stock quantity of the commodity object.

When stock occupation operation is performed for a commodity object, the specific storage location of the occupied commodity stock may be recorded. That way, only storage locations in which stock has been occupied are counted during subsequent stock counting. The workload of stock counting can be effectively reduced, thereby increasing the efficiency of stock counting.

In light of the above, the order processing systems provided in some embodiments of the present disclosure perform back-of-house stock occupation for the commodity object related to the order when the back-of-house commodity stock is sufficient. With such techniques, order-picking for online orders targets back-of-house commodity stock, and offline commodity sales target front-of-house commodity stock, preventing online orders and offline commodity sales from competing for the same commodity stock. Occurrence of failed order-picking for an order that occupies back-of-house stock can be prevented, thereby effectively improving order-picking and delivery efficiency.

Still referring to FIG. 1, after the order is generated by order generation unit 1011, order processing system 100 can first start back-of-house stock determination unit 1013 to determine whether the back-of-house stock quantity of the commodity object related to the order satisfies the quantity ordered by the user. If the back-of-house stock quantity of the commodity object related to the order satisfies the quantity ordered by the user, back-of-house order processing unit 1015 can be started. Back-of-house order processing unit 1015 can be configured to perform back-of-house stock occupation for the commodity object related to the order.

Further, according to some embodiments, when the back-of-house stock occupation is performed successfully for the commodity object related to the order, the stock occupation type of the order can be labeled as a back-of-house type. This type of order can be referred to as a back-of-house order. With such labeling, during subsequent order-picking batch generation, a back-of-house order can be included in a back-of-house order-picking batch according to the order label, thus ensuring the order-picking and delivery efficiency of the back-of-house order.

In some embodiments, when back-of-house stock occupation is performed for the commodity object related to the order, the back-of-house commodity stock may be occupied randomly. Alternatively, back-of-house stock occupation may be performed according to a preset storage location occupation rule.

Randomly occupying back-of-house commodity stock may indicate that any back-of-house stock can be occupied. Back-of-house stock occupation can be performed as long as the total quantity of the back-of-house stock satisfies the order quantity. Alternatively, a storage location occupation rule can be set to limit the manners of occupying back-of-house storage locations. The storage location occupation rule may indicate the types of back-of-house storage locations in which commodity stock can be occupied, or it can directly specify the specific back-of-house storage locations in which commodity stock can be occupied.

In actual operations of a store, the stock of one commodity object may be stored in multiple storage locations. Some of the storage locations may be located in the front-of-house of the store, and some of the storage locations may be located in the back-of-house of the store. In addition, among the multiple storage locations in the back-of-house of the store, the stock of some storage locations can be occupied by online orders, and the stock of some storage locations may not be occupied by online orders. For example, the types of back-of-house storage locations can be classified as order-picking positions, processing positions, storage positions, and return positions. For online orders, commodity stock stored in return positions usually cannot be occupied by online orders. Therefore, it may be necessary to specify, using the back-of-house occupation rule, the types of back-of-house storage locations in which commodity stock can be occupied, or the specific back-of-house storage locations in which commodity stock can be occupied.

For example, the storage location occupation rule may be set as follows: back-of-house stock in order-picking positions, processing positions, and storage positions can be occupied, and back-of-house stock in return positions cannot be occupied. Alternatively, the storage location occupation rule may be set as follows: stock in back-of-house storage locations A, B, and C can be occupied.

It is appreciated that the storage location occupation rule may be a universal rule for all orders, or it may be a rule applicable for specific commodity objects. For example, the storage location occupation rule may be set as follows: all commodity objects can occupy back-of-house stock in order-picking positions, processing positions, and storage locations. As another example, the storage location occupation rule may be set as follows: “vegetable” commodity objects can only occupy back-of-house stock in order-picking positions and storage locations, etc.

When managing the back-of-house stock that can be occupied by the order according to the preset storage location occupation rule, it may be necessary to first calculate the stock quantity that can be occupied in the back-of-house. In some embodiments, the back-of-house stock determination unit 1013 may include a back-of-house stock quantity acquisition sub-unit 10131 and a back-of-house stock determination sub-unit 10133.

Back-of-house stock quantity acquisition sub-unit 10131 can be configured to acquire, according to the preset storage location occupation rule, storage location information of the back-of-house stock that can be occupied by the commodity object, and acquire the back-of-house stock quantity of the commodity object according to the stock quantity of each of the storage locations. Back-of-house stock determination sub-unit 10133 can be configured to determine whether the acquired back-of-house stock quantity is greater than or equal to the ordered quantity.

According to the preset storage location occupation rule, the storage location information of the back-of-house stock that can be occupied by the commodity objects can be acquired. For example, the storage location occupation rule may be “all commodity objects can occupy back-of-house stock in order-picking positions, processing positions, and storage positions.” The acquired storage location information of the back-of-house stock that can be occupied by the commodity objects can be: identifiers of all storage locations in order-picking positions, processing positions, and storage positions in the back-of-house in which stock of the commodity objects related to the order is stored. For example, storage locations of the order-picking position, processing position and storage position types storing “tomato” may include: storage location 1, storage location 3, storage location 4, and so on. The stock of each storage location is usually recorded in the order processing system. By querying these records, the stock quantity corresponding to each storage location can be acquired. After the stock quantities of these storage locations are processed statistically, the back-of-house stock quantity of the commodity object can be acquired.

In addition, in some embodiments, the commodity ordering information input by the user may include ordering information for a plurality of commodity objects. In that case, back-of-house stock determination unit 1013 may separately determine, for each commodity object ordered by the user, whether the back-of-house stock quantity of the commodity object satisfies the corresponding order quantity of that commodity object. When the back-of-house stock quantities of all the commodity objects satisfy the corresponding ordering quantities, back-of-house order processing unit 1015 can be started to perform back-of-house stock occupation for the various commodity objects related to the order. Back-of-house order processing unit 1015 can further label the stock occupation type of the order as the back-of-house type.

In practical applications, the back-of-house stock of the commodity object may not meet the user's purchase demand. For example, the user may want to purchase 5 items of commodity object A, but there are only 4 items of commodity object A in the back-of-house stock. Therefore, the back-of-house stock quantity of the commodity object cannot satisfy the order quantity. In the following, stock occupation processing performed when the back-of-house stock quantity of the commodity object cannot satisfy the order quantity is further described.

Still referring to FIG. 1, order processing apparatus 101 can further include a non-back-of-house order processing sub-unit 1017. When the determination result of the back-of-house stock determination unit 1013 is no, that is, when the back-of-house stock quantity of the commodity object cannot satisfy the order quantity, non-back-of-house order processing sub-unit 1017 can be started.

Non-back-of-house order processing sub-unit 1017 can be configured to: perform stock occupation for the commodity object related to the order according to a preset stock occupation mode; label the stock occupation type of the order as a front-of-house type if the order occupies front-of-house stock; and label the stock occupation type of the order as a front-back-of-house hybrid type if the order occupies front-of-house stock and back-of-house stock.

Non-back-of-house order processing sub-unit 1017 can perform stock occupation for the commodity object related to the order according to the preset stock occupation mode. The preset stock occupation mode can indicate the manner of performing stock occupation for the commodity object when back-of-house stock occupation cannot be performed for the entire order associated with commodity object. The preset stock occupation mode can include, but is not limited to, occupying front-of-house stock after the back-of-house stock is fully occupied, or occupying back-of-house stock after the front-of-house stock is fully occupied, or occupying front-of-house stock only. For example, if the preset stock occupation mode indicates “occupying front-of-house stock after the back-of-house stock is fully occupied,” all available back-of-house stock will be occupied first, and for the remaining stock quantity, front-of-house stock will be occupied.

It is appreciated that the stock occupation mode may be a universal mode for all orders or a mode for specific commodity object(s). For example, the stock occupation mode may be set as follows: all commodity objects “occupy front-of-house stock after the back-of-house stock is fully occupied.” As another example, the stock occupation mode may be set as follows: “vegetable” commodity objects “occupy front-of-house stock after the back-of-house stock is fully occupied.”

Non-back-of-house order processing sub-unit 1017, after performing stock occupation for the commodity object related to the order, can label the stock occupation type of the order according to the specific stock occupation situation. For example, non-back-of-house order processing sub-unit 1017 can label the order occupation type of the order as the front-of-house type if the order occupies front-of-house stock, or label the stock occupation type of the order as the front-back-of-house hybrid type if the order occupies both front-of-house stock and back-of-house stock.

In some embodiments, the order may include multiple commodity objects. The back-of-house stock quantities of a part of the commodity objects can satisfy the ordering quantities, and the back-of-house stock quantities of the other part of the commodity objects may not satisfy the ordering quantities. In that case, back-of-house stock occupation can be performed for the commodity objects with back-of-house stock quantities satisfying the ordering quantities. For the commodity objects with back-of-house stock quantities not satisfying the ordering quantities, all available back-of-house stock can be occupied first, and front-of-house stock can then be occupied for the part of the ordering quantities that are not satisfied. With the above techniques, front and back-of-house stock competition can be reduced.

When the order includes multiple commodity objects, labeling the stock occupation type of the order may need to reference the stock occupation mode of each commodity object. When all the commodity objects occupy back-of-house stock, the stock occupation type of the order can be labeled as the back-of-house type. When all the commodity objects occupy front-of-house stock, the stock occupation type of the order can be labeled as the front-of-house type. If some commodity objects occupy front-of-house stock and some commodity objects occupy back-of-house stock, or if some commodity objects occupy both back-of-house stock and front-of-house stock, the stock occupation type of the order may be labeled as a front-back-of-house hybrid type.

An example of order processing by order processing apparatus 101 is described below. For example, a user orders 10 kg of “tomato,” 7.5 kg of “celery,” and 25 kg of “pork.” If the back-of-house stock of “tomato” is 25 kg, the back-of-house stock of “celery” is 15 kg, and the back-of-house stock of “pork” is 25 kg, the back-of-house stock quantities of the various ordered commodity objects all satisfy the ordering quantities. Therefore, back-of-house stock occupation can be performed for the order, and the stock occupation type of the order can be labeled as a back-of-house type. As another example, if the back-of-house stock of “tomato” is 5 kg, the back-of-house stock of “celery” is 15 kg, and the back-of-house stock of “pork” is 25 kg, the back-of-house stock quantity of “tomato” cannot satisfy the order quantity. Therefore, “tomato” will occupy 5 kg of back-of-house stock and 5 kg of front-of-house stock, the other two commodity objects will occupy back-of-house stock. The stock occupation type of the order will be labeled as the front-back-of-house hybrid type.

The order processed by order processing apparatus 101 can be stored in an order pool (for example, order pool of outgoing orders 103 in FIG. 1). When an order-picking batch generation operation is triggered, order-picking batch generation apparatus 102 can be started to combine the orders in the order pool into order-picking batches.

The manner of generating order-picking batches can be based on customer-defined dimensions. For example, order-picking batches can be generated based on dimensions such as delivery time, delivery address, and commodity weight and volume. However, for stores that support online and offline sales simultaneously, generating order-picking batches based on these dimensions may cause the problem of failed order-picking of an online order of a commodity if the same commodity has been bought offline.

According to some embodiments of the present disclosure, outgoing orders can be included in order-picking batches matching their attributes according to the stock occupation types of the orders. As shown in FIG. 1, order-picking batch generation apparatus 102 can include an order acquisition unit 1021 and an order batching unit 1023. Order acquisition unit 1021 can be configured to acquire at least one outgoing order. Order batching unit 1023 can be configured to include the at least one order in an order-picking batch matching an attribute of the order, according to the stock occupation type of the order.

As mentioned above, the stock occupation type of the order may include: a back-of-house order, a front-of-house order, and a front-back-of-house hybrid order. One purpose of labeling the order as a back-of-house type, a front-of-house type, or a front-back-of-house hybrid type is to group the orders of different stock occupation types into different order-picking batches. This processing technique can group orders of the back-of-house type in a back-of-house order-picking batch matching their attributes, instead of grouping orders of the back-of-house type with orders of the front-of-house type or the front-back-of-house hybrid type in one order-picking batch. That way, separate order-picking for orders of the back-of-house type can be implemented. Order-picking can be implemented smoothly and efficiently for the orders.

When triggering the order-picking batch generation operation, order processing system 100 may first take at least one outgoing order, i.e., an order requiring order-picking and delivery, from order pool of outgoing orders 103 through order acquisition unit 1021. Then, orders of different stock occupation types can be grouped into different order-picking batches by order batching unit 1023.

In some embodiments, order batching unit 1023 may include the following units: a back-of-house order batching sub-unit a front-of-house order batching sub-unit and a front-back-of-house hybrid order batching sub-unit.

Back-of-house order batching sub-unit can be configured to select orders of the back-of-house type from at least one outgoing order, and then include each order of the back-of-house type in a back-of-house order-picking batch matching an attribute of the order, according to a preset order batching rule.

Front-of-house order batching sub-unit can be configured to select orders of the front-of-house type from at least one outgoing order, and then include each order of the front-of-house type in a front-of-house order-picking batch matching an attribute of the order, according to the preset order batching rule.

Front-back-of-house hybrid order batching sub-unit can be configured to select orders of the front-back-of-house hybrid type from at least one outgoing order, and then include each order of the front-back-of-house hybrid type in a front-back-of-house hybrid order-picking batch matching an attribute of the order, according to the preset order batching rule.

The preset order batching rule may refer to a rule according to which the outgoing orders are batched. The preset order batching rule may be set according to actual application requirements.

In practical applications, a deliverer usually delivers commodities associated with adjacent delivery addresses in a centralized manner. For example, commodities associated with delivery addresses within the range of Zhongguancun Street may be distributed to a deliverer responsible for delivery in that area for unified delivery. The preset order batching rule can be formed based on the area to which the delivery address of the order belongs.

In addition, different orders may feature different degrees of delivery urgency, different weight and volume levels, etc. The preset order batching rule may also be formed based on the area of the delivery address of the order, the delivery urgency, the weight and volume level, and other attributes. With the above processing, orders can be delivered and managed with finer granularity.

In some embodiments, the urgency types of the orders can be classified into a scheduled type and an immediate type, and the weight and volume levels of the orders can be classified into a normal type and a large type. The order batching rule can be set according to the urgency type, the weight volume level, and the area of the delivery address of the order. For example, the preset order batching rule may include the following rules: 1) orders having delivery addresses belonging to the same area, weight and volume levels of the large type, and urgency of the immediate type are combined into one batch for processing; 2) orders having delivery addresses belonging to the same area, weight and volume levels of the large type, and urgency of the scheduled type are combined into one batch for processing; 3) orders having delivery addresses belonging to the same area, weight and volume levels of the normal type, and urgency of the immediate type are combined into one batch for processing; and 4) orders having delivery addresses belonging to the same area, weight and volume levels of the normal type, and urgency of the scheduled type are combined into one batch for processing.

It is appreciated that the preset order batching rule described above is only exemplary. In an actual applications, the order type of a to-be-delivered order may be set to other types according to application requirements, and correspondingly, the preset order batching rule may be set differently from those described above. Consistent with the present disclosure, variations of the above-mentioned different forms of order batching rules may be designed and implemented.

Exemplary order-picking batches generated by order processing system 100 are described below. For example, there are 100 outgoing orders, among which 70 orders are orders of the back-of-house type, 20 orders are orders of the front-back-of-house hybrid type, and 10 orders are orders of the front-of-house type. The following order-picking batches can be generated by order processing system 100 provided in this scenario. Order processing system may generate 5 back-of-house order-picking batches each corresponding to a different delivery area, a different urgency level, and a different weight and volume level. Commodities of these batches are all stored in the back-of-house of the store. Order processing system may generate three front-back-of-house hybrid order-picking batches, each corresponding to a different delivery area, a different urgency level, and a different weight and volume level. Some commodities of these batches are stored in the back-of-house of the store, and some are stored in the front-of-house of the store. Order processing system 100 may further generate 4 front-of-house order-picking batches each corresponding to a different delivery area, a different urgency level, and a different weight and volume level. Commodities of these batches are all stored in the front-of-house of the store. During order-picking for the above 5 back-of-house order-picking batches, the problem of front and back-of-house stock competition will not occur.

With the above-described order processing systems provided in the present disclosure, stock of a commodity can be separately stored in a front-of-house and a back-of-house of a store, and the commodity storage locations can be set as front-of-house types and back-of-house types. When the store receives an online order, back-of-house stock occupation can be performed for the order. If the back-of-house stock occupation is successful, the stock occupation type of the order can be labeled as the back-of-house type. When an order-picking batch is generated, the outgoing orders can each be included in an order-picking batch matching an attribute of the order according to the stock occupation type of the order. Accordingly, stock occupied by online orders can be effectively separated from stock of commodities sold offline, so that online stock and offline stock will not affect each other, thus avoiding the problem of failed order-picking and delivery due to insufficient stock of online orders. Therefore, the order processing system provided in the present disclosure can effectively improve the order-picking and delivery efficiency.

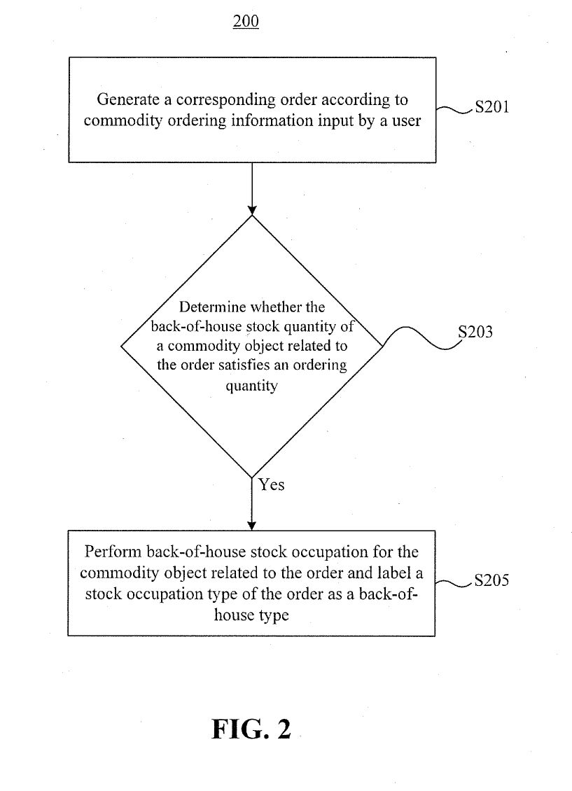

According to some embodiments of the present disclosure, order processing methods are further provided. FIG. 2 is a flowchart of an exemplary order processing method 200 according to some embodiments. Some procedures of order processing method 200 may be similar to those described above with respect to the system embodiments. For procedures not described in detail herein, reference can be made to the corresponding description above. As shown in FIG. 2, The order processing method according to this application includes the following procedures, steps S201-S205.

In step S201, a corresponding order is generated according to commodity ordering information input by a user.

In step S203, it is determined whether the back-of-house stock quantity of a commodity object related to the order satisfies an order quantity. If the back-of-house stock quantity of a commodity object related to the order satisfies the order quantity, step S205 can be performed.

In step S205, back-of-house stock occupation is performed for the commodity object related to the order, and the stock occupation type of the order is labeled as a back-of-house type.

In some embodiments, before step S203, the method may further include: step S2021, acquiring, according to a preset storage location occupation rule, storage location information of the back-of-house stock that can be occupied by the commodity object; and step 2022, acquiring the back-of-house stock quantity of the commodity object according to the stock quantity of each of the storage locations.

The preset storage location occupation rule can include at least one of the following rules: a universal storage location occupation rule for orders, and a storage location occupation rule applicable for specific commodity objects.

In some embodiments, the commodity object related to the order may include a plurality of commodity objects. Correspondingly, step S203 may include the following procedures: determining whether the back-of-house stock quantity of each of the commodity objects satisfies the corresponding order quantity. If the back-of-house stock quantities of the various commodity objects all satisfy the corresponding ordering quantities, then the process proceeds to step S205.

In some embodiments, if the back-of-house stock quantity of a commodity object related to the order does not satisfy an order quantity, order processing method 200 can further include: performing stock occupation for the commodity object related to the order according to a preset stock occupation mode; labeling the stock occupation type of the order as a front-of-house type if the order occupies front-of-house stock; and labeling the stock occupation type of the order as a front-back-of-house hybrid type if the order occupies front-of-house stock and back-of-house stock.

The preset stock occupation mode can include: occupying front-of-house stock after the back-of-house stock is fully occupied, occupying front-of-house stock after the front-of-house stock is fully occupied, or occupying the front-of-house stock only.

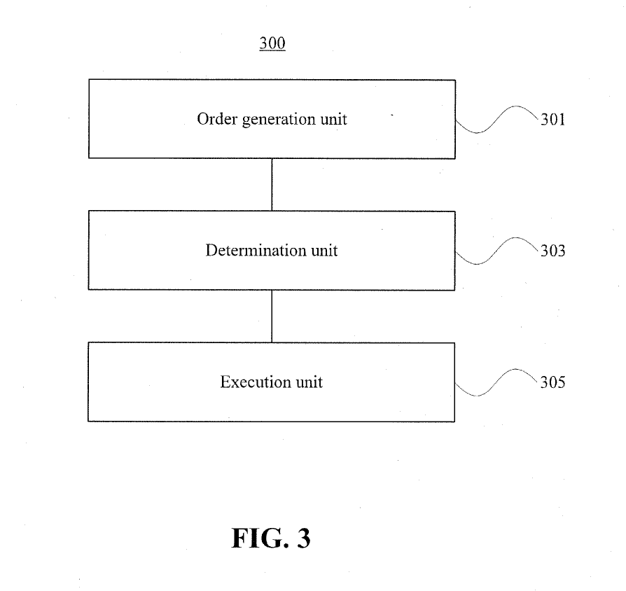

According to some embodiments of the present disclosure, order processing apparatuses are further provided. The order processing apparatuses may perform procedures similar to those described above in the method embodiments. FIG. 3 is a schematic diagram of an exemplary order processing apparatus 300 according to some embodiments. The apparatus embodiments are described herein in a relatively concise manner. Reference can be made to the description above with respect to the system and method embodiments. As shown in FIG. 3, order processing apparatus 300 includes an order generation unit 301, a determination unit 303, and an execution unit 305.

Order generation unit 301 can be configured to generate a corresponding order according to commodity ordering information input by a user.

Determination unit 303 can be configured to determine whether the back-of-house stock quantity of a commodity object related to the order satisfies the order quantity.

Execution unit 305 can be configured to: if the back-of-house stock quantity of a commodity object related to the order satisfies the order quantity, perform back-of-house stock occupation for the commodity object related to the order and label the stock occupation type of the order as a back-of-house type.

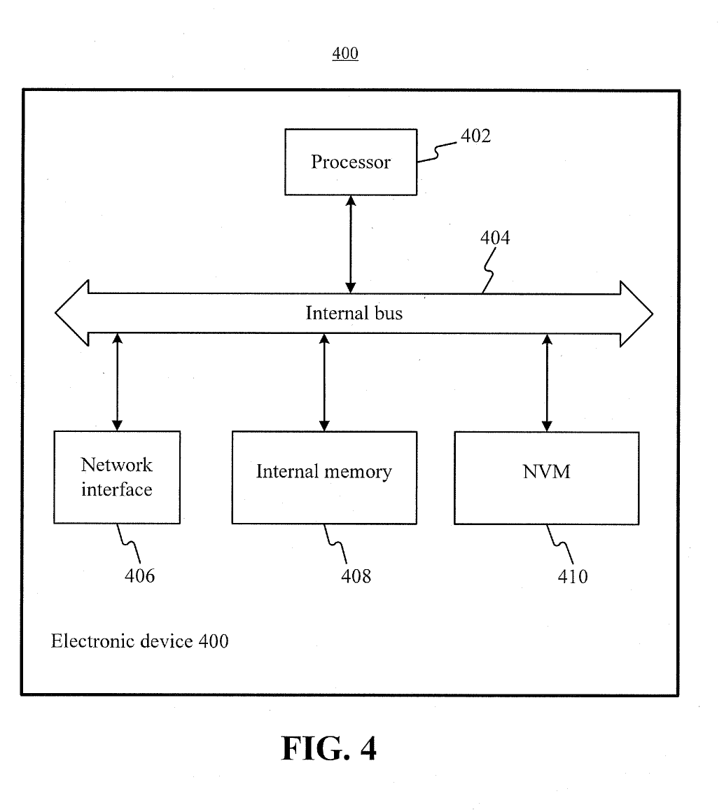

According to some embodiments of the present disclosure, electronic devices are further provided. FIG. 4 is a schematic diagram of an electronic device 400 according to some embodiments. Referring to FIG. 4, electronic device 400 includes a processor 402, an internal bus 404, a network interface 406, and a memory such as an internal memory 408 and a nonvolatile memory (NVM) 410. Processor 402 can be configured to execute instructions stored in the memory for performing procedures associated with the above described order processing methods. For procedures not described in detail herein, reference can be made to the corresponding description above with respect to the method embodiments.

For example, internal memory 408 or nonvolatile memory 410 can be configured to store a program for implementing an order processing method, wherein when the program is executed through the processor 402, the following procedures can be performed: generating a corresponding order according to commodity ordering information input by a user; determining whether a back-of-house stock quantity of a commodity object related to the order satisfies the order quantity; and if the back-of-house stock quantity of a commodity object related to the order satisfies the order quantity, performing back-of-house stock occupation for the commodity object related to the order, and labeling a stock occupation type of the order as a back-of-house type.

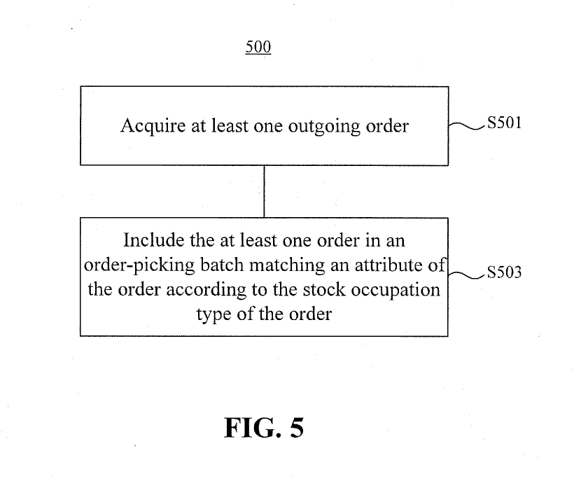

According to some embodiments of the present disclosure, order-picking batch generation methods are further provided. FIG. 5 is a flowchart of an exemplary order-picking batch generation method 500 according to some embodiments. It is appreciated that order-picking batch generation method 500 may include procedures similar to those described above with respect to the system embodiments. For procedures not described in detail below, reference can be made to the corresponding description above. As shown in FIG. 5, order-picking batch generation method 500 may include the following steps S501-S503.

In step S501, at least one outgoing order is acquired.

In step S503, the at least one order is included in an order-picking batch matching an attribute of the order according to the stock occupation type of the order.

The stock occupation types can include: a back-of-house type, a front-of-house type, or a front-back-of-house hybrid type.

In some embodiments, step S503 may include the following procedures: 1) selecting orders of the back-of-house type from the at least one order, and including each order of the back-of-house type in a back-of-house order-picking batch matching an attribute of the order, according to a preset order batching rule; 2) selecting orders of the front-of-house type from the at least one order, and including each order of the front-of-house type in a front-of-house order-picking batch matching an attribute of the order, according to the preset order batching rule; and 3) selecting orders of the front-back-of-house hybrid type from the at least one order, and including each order of the front-back-of-house hybrid type in a front-back-of-house hybrid order-picking batch matching an attribute of the order, according to the preset order batching rule.

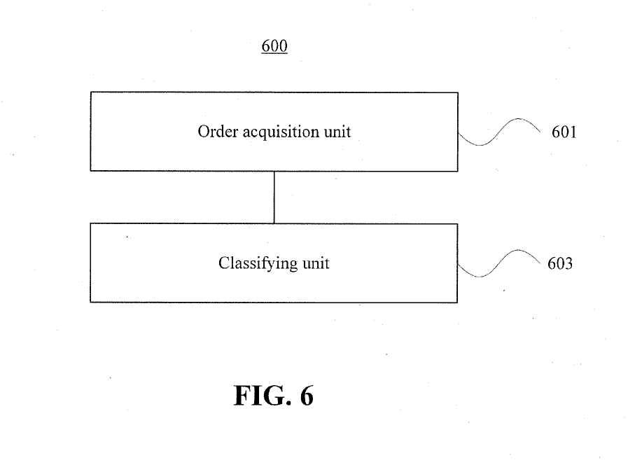

According to some embodiments, order-picking batch generation apparatuses are further provided. FIG. 6 is a schematic diagram of an exemplary order-picking batch generation apparatus 600 according to some embodiments. Order-picking batch generation apparatus 600 may perform procedures similar to those described above in the system and method embodiments. For procedures not described in detail herein, reference can be made to corresponding description above. As shown in FIG. 6, order-picking batch generation apparatus 600 can include an order acquisition unit 601, and a classifying unit 603.

Order acquisition unit 601 can be configured to acquire at least one outgoing order.

Classifying unit 603 can be configured to include the at least one order in an order-picking batch matching an attribute of the order, according to the stock occupation type of the order.

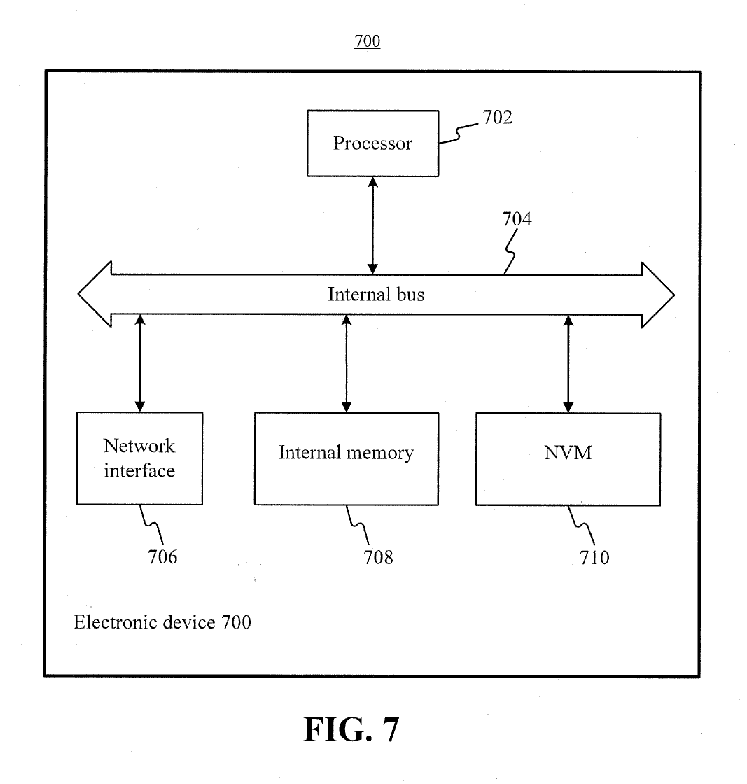

According to some embodiments, electronic devices are further provided. FIG. 7 is a schematic diagram of an exemplary electronic device 700 according to this application. Electronic device 700 may perform procedures similar to those described above in the system and method embodiments. For procedures not described in detail herein, reference can be made to corresponding description above. Referring to FIG. 7, electronic device 700 includes a processor 702, an internal bus 704, a network interface 706, and a memory such as an internal memory 708 and a nonvolatile memory (NVM) 710. Processor 702 can be configured to execute instructions stored in the memory for performing the above described methods.

For example, internal memory 708 or nonvolatile memory 710 can be configured to store a program for implementing an order-picking batch generation method. When the program is executed through the processor, the following procedures can be performed: acquiring at least one outgoing order; and including the at least one order in an order-picking batch matching an attribute of the order, according to the stock occupation type of the order.

It is appreciated that embodiments of the present disclosure may be implemented in different manners, such as in the form of methods, systems, or computer program products. For example, embodiments of the present disclosure may be implemented in the form of a pure hardware embodiment, a pure software embodiment, or an embodiment combining software and hardware. Moreover, some embodiments may be implemented in the form of a computer program product implemented on one or more computer-usable storage media (including, but are not limited to, magnetic disk memory, CD-ROM, optical memory, and the like) that contain computer-usable program codes. The computer-usable codes can be used for instructing a computer device (such as electronic devices 400 and 700) or a processor (such as CPU) to perform some or all of the steps of the method embodiments of the present disclosure. The computer device may be a personal computer, a server, or a network device. The foregoing storage medium can include any medium that can store program codes, such as a USB flash drive, a mobile hard disk, a Read-Only Memory (ROM), a Random Access Memory (RAM), a magnetic disk, or an optical disc. The storage medium can be a non-transitory computer readable medium. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM any other memory chip or cartridge, and networked versions of the same.

In a typical configuration, a computing device can include one or more processors (CPUs), an input/output interface, a network interface, and a memory. The memory may be in the form of a volatile memory, a random access memory (RAM), and/or a non-volatile memory, such as a read-only memory (ROM) or a flash RAM, in a computer-readable medium. Memory can be an example of a computer readable medium. As noted above, computer readable media may include non-volatile or volatile, and movable or non-movable media, and may implement information storage using various methods. The stored information may be computer readable instructions, data structures, program modules, or other data. Examples of computer storage media include, without limitation, phase change memory (PRAM), static random access memory (SRAM), dynamic random access memory (DRAM) and other types of random access memory (RAM), read-only memory (ROM), electrically erasable programmable read-only memory (EEPROM), flash memory or other memory technologies, compact disc read-only memory (CD-ROM), digital versatile disc (DVD) or other optical storages, cassette tape, magnetic tape/magnetic disk storage or other magnetic storage devices, or any other non-transitory medium. These computer storage media may be used to store information accessible to the computing device. As used in the present disclosure, computer-readable media do not include transitory media, such as modulated data signals and carriers.

It is appreciated that the above described embodiments are only exemplary. Consistent with the present disclosure, those of ordinary skill in the art may incorporate variations and modifications in actual implementation, without departing from the principles of the present disclosure. Such variations and modifications shall all fall within the protection scope of the present disclosure.

1. An order processing method, comprising:
generating an order according to user input;
determining whether a back-of-house stock quantity of an object associated with the order satisfies an order quantity;
in response to a determination that the back-of-house quantity of the object associated with the order satisfies the order quantity, perform back-of-house stock occupation for the object; and
labeling a stock occupation type of the order as a back-of-house type.

2. The order processing method according to claim 1, wherein before determining whether the back-of-house stock quantity of the object associated with the order satisfies the order quantity, the method further comprises:
acquiring, according to a preset occupation rule, storage location information of back-of-house stock that can be occupied by the object; and
determining the back-of-house stock quantity of the object according to a stock quantity of each storage location.

3. The order processing method according to claim 2, wherein the preset occupation rule comprises at least one of:
a storage location occupation rule for a plurality of orders, and
a storage location occupation rule for the object.

4. The order processing method according to claim 1, wherein:
the object associated with the order comprises a plurality of objects, and
determining whether the back-of-house stock quantity of the object associated with the order satisfies the order quantity comprises:
determining whether a back-of-house quantity of each of the plurality of objects satisfies a corresponding order quantity.

5. The order processing method according to claim 1, further comprising:
in response to a determination that the back-of-house stock quantity of the object associated with the order does not satisfy the order quantity, performing stock occupation for the object according to a preset occupation mode;
labeling the stock occupation type of the order as a front-of-house type if the order occupies front-of-house stock; and
labeling the stock occupation type of the order as a front-back-of-house hybrid type if the order occupies the front-of-house stock and back-of-house stock.

6. The order processing method according to claim 5, wherein the preset occupation mode comprises:
occupying the front-of-house stock after the back-of-house stock is fully occupied,
occupying the back-of-house stock after the front-of-house stock is fully occupied, or
occupying the front-of-house stock only.

7. An order processing device, comprising:
a memory storing instructions; and
at least one processor configured to execute the instructions to cause the order processing device to:
generate an order according to user input;
determine whether a back-of-house stock quantity of an object associated with the order satisfies an order quantity;
if the back-of-house quantity of the object associated with the order satisfies the order quantity, perform back-of-house stock occupation for the object; and
label a stock occupation type of the order as a back-of-house type.

8. An order-picking batch generation method, comprising:
acquiring at least one outgoing order; and
classifying the at least one outgoing order into a corresponding order-picking batch, based on a stock occupation type of the at least one outgoing order.

9. The order-picking batch generation method according to claim 8, wherein the stock occupation type comprises at least one of: a back-of-house type, a front-of-house type, or a front-back-of-house hybrid type.

10. The order-picking batch generation method of claim 9, wherein classifying the at least one outgoing order into the corresponding order-picking batch comprises:
selecting orders of the back-of-house type from the at least one outgoing order, and classifying each order of the back-of-house type into a back-of-house order-picking batch;
selecting orders of the front-of-house type from the at least one outgoing order, and classifying each order of the front-of-house type in a front-of-house order-picking batch; and
selecting orders of the front-back-of-house hybrid type from the at least one outgoing order, and classifying each order of the front-back-of-house hybrid type in a front-back-of-house hybrid order-picking batch.

11. The order-picking batch generation method according to claim 8, wherein classifying the at least one outgoing order into the corresponding order-picking batch is further based on at least one of the following attributes of the at least one outgoing order:
a delivery address,
a delivery urgency level, or
a weight and volume level.

12-21. (canceled)

22. A non-transitory computer readable medium that stores a set of instructions, that is executable by at least one processor of a computer to perform an order processing method, the method comprising:
generating an order according to user input;
determining whether a back-of-house stock quantity of an object associated with the order satisfies an order quantity;
in response to a determination that the back-of-house quantity of the object associated with the order satisfies the order quantity, perform back-of-house stock occupation for the object; and
labeling a stock occupation type of the order as a back-of-house type.

23. The non-transitory computer readable medium according to claim 22, wherein before determining whether the back-of-house stock quantity of the object associated with the order satisfies the order quantity, the set of instructions that is executable by the at least one processor of the computer causes the computer to further perform:
acquiring, according to a preset occupation rule, storage location information of back-of-house stock that can be occupied by the object; and
determining the back-of-house stock quantity of the object according to a stock quantity of each storage location.

24. The non-transitory computer readable medium according to claim 23, wherein the preset occupation rule comprises at least one of:
a storage location occupation rule for a plurality of orders, and
a storage location occupation rule for the object.

25. The non-transitory computer readable medium according to claim 22, wherein:
the object associated with the order comprises a plurality of objects, and
determining whether the back-of-house stock quantity of the object associated with the order satisfies the order quantity comprises:
determining whether a back-of-house quantity of each of the plurality of objects satisfies a corresponding order quantity.

26. The non-transitory computer readable medium according to claim 22, wherein the set of instructions that is executable by the at least one processor of the computer causes the computer to further perform:
in response to a determination that the back-of-house stock quantity of the object associated with the order does not satisfy the order quantity, performing stock occupation for the object according to a preset occupation mode;
labeling the stock occupation type of the order as a front-of-house type if the order occupies front-of-house stock; and
labeling the stock occupation type of the order as a front-back-of-house hybrid type if the order occupies the front-of-house stock and back-of-house stock.

27. The non-transitory computer readable medium according to claim 26, wherein the preset occupation mode comprises:
occupying the front-of-house stock after the back-of-house stock is fully occupied,
occupying the back-of-house stock after the front-of-house stock is fully occupied, or
occupying the front-of-house stock only.

28-31. (canceled)
